(19) United States
(12) Patent Application Publication
(10) Pub. No.: US 2013/0278208 A1
(43) Pub. Date: Oct. 24, 2013

(54) STORAGE-BATTERY INDUCTIVE CHARGING DEVICE

(71) Applicants: Marcin REJMAN, Waiblingen (DE); Volker AMANN, Augsburg (DE); Guenter LOHR, Leinfelden-Echterdingen (DE); Juergen MACK, Goeppingen (DE); Friederike DIETZEL, Stuttgart (DE); Brett HUBER, Arlington Heights, IL (US)

(72) Inventors: Marcin REJMAN, Waiblingen (DE); Volker AMANN, Augsburg (DE); Guenter LOHR, Leinfelden-Echterdingen (DE); Juergen MACK, Goeppingen (DE); Friederike DIETZEL, Stuttgart (DE); Brett HUBER, Arlington Heights, IL (US)

(73) Assignee: ROBERT BOSCH GMBH, Stuttgart (DE)

(21) Appl. No.: 13/869,580

(22) Filed: Apr. 24, 2013

(30) Foreign Application Priority Data
Apr. 24, 2012 (DE) 10 2012 206 727.2

(51) Int. Cl. H02J 7/02

(52) U.S. Cl. CPC H02J 7/025
USPC 320/108; 320/137

(57) ABSTRACT

A storage-battery inductive charging device, particularly a hand-held-tool storage-battery inductive charging device, for a motor vehicle, having at least one functional unit and at least one charging coil. The functional unit is intended at least to control a charging process of the charging coil as a function of at least one energy-availability characteristic.

### CROSS REFERENCE

The present application claims the benefit under 35 U.S.C. §119 of German Patent Application No. DE 102012206727.2 filed on Apr. 24, 2012, which is expressly incorporated herein by reference in its entirety.

### BACKGROUND INFORMATION

A storage-battery inductive charging device, particularly a hand-held-tool storage-battery inductive charging device, for a motor vehicle, having at least one functional unit and at least one charging coil is available.

### SUMMARY

The present invention is based on a storage-battery inductive charging device, particularly for a motor vehicle, having at least one functional unit and at least one charging coil.

In accordance with an example embodiment of the present invention, the functional unit is provided at least to control a charging process of the charging coil as a function of at least one energy-availability characteristic. In particular, at least a passenger car and/or a truck are to be understood as a “motor vehicle.” Preferably, the functional unit has at least one arithmetic-logic unit. Alternatively or additionally, the functional unit especially could have an analog circuit appearing to be useful to one skilled in the art. An “arithmetic-logic unit” is to be understood especially as a unit having an information input, information processing and an information output. Advantageously, the arithmetic-logic unit has at least a processor, a memory, input and output elements, an operating program, regulating routines, control routines and/or calculation routines. The functional unit preferably takes the form of a microcontroller. A “charging coil” is to be understood especially as a coil which receives a charge energy during a charging process and/or advantageously transmits it. During a charging process, the charging coil of the storage-battery inductive charging device preferably transmits the charge energy to a charging coil of a hand-held tool and/or, advantageously, of a hand-held-tool storage battery. Preferably, the charging coil includes at least one coil winding and, in particular, a coil core. Alternatively or additionally, the charging coil could take the form of an air-cored coil. Preferably, the charging coil is formed as a conductor track on a board, or especially preferred, as a wound coil. In particular, the term “intended” is to be understood as specially programmed, designed and/or furnished. A “hand-held-tool storage battery” is to be understood especially as a storage battery which is intended to supply the hand-held tool with energy, particularly during a work operation. In a ready-to-operate state, preferably, the hand-held-tool storage battery is joined to the hand-held tool in a manner releasable especially without using a tool. Alternatively or additionally, a hand-held-tool storage battery could be integrated into the hand-held tool. In particular, a “hand-held tool” is to be understood as a portable tool, for example, a drill, a hammer drill, an impact hammer, a saw, a planer, a screwdriver, a milling machine, a grinder, an angle grinder, a gardening tool, a construction-site measuring device and/or a multi-functional tool. A “charging process” is to be understood especially as a process during which the charging coil transfers a charge energy to a hand-held-tool storage battery, and the hand-held-tool storage battery stores the charge energy. In particular, an “energy-availability characteristic” is to be understood as a characteristic which has information at least about a power and/or, advantageously, amount of energy callable from the motor vehicle. Preferably, the energy-availability characteristic has information about an amount of energy stored by a battery of the motor vehicle. For example, the energy-availability characteristic could be a function of a voltage of the motor-vehicle battery. Advantageously, the energy-availability characteristic has information about an electric power which the motor vehicle is making available to the storage-battery inductive charging device. For example, the energy-availability characteristic is a function of whether an alternator, a generator and/or a fuel cell of the motor vehicle is in operation, and/or how much energy is needed by other internal and/or external motor-vehicle loads supplied by 12 volts, for instance, especially an air conditioner, a heater and/or a light of the motor vehicle. Preferably, the energy-availability characteristic is a function of an operating state of the motor vehicle. For example, the energy-availability characteristic could be a function of whether an ignition of the motor vehicle is switched on. In particular, to be understood by the phrase “control as a function of at least one energy-availability characteristic” is that the functional unit is intended to determine, on the basis of the energy-availability characteristic, at least an energy transferred during a charging process. Preferably, the functional unit is intended to determine a power transferred during a charging process in at least one operating state as a function of at least the energy-availability characteristic. Preferably, the functional unit is intended to charge the hand-held-tool storage battery up to a state of charge as a function of the energy-availability characteristic, e.g., up to half full. “At least to control” is to be understood, in particular, as to control and/or to regulate. Owing to the embodiment of the storage-battery inductive charging device of the present invention, it is possible to achieve an advantageous charging of the hand-held-tool storage battery, in spite of a limited availability of electric power. In particular, a complete discharging of the motor-vehicle storage battery is able to be avoided when charging the hand-held-tool storage battery from the storage battery of the motor vehicle.

In a further development, the storage-battery inductive charging device has a communication interface that, in at least one operating state, receives the energy-availability characteristic, thereby permitting access to especially accurate information about an availability of energy. To be understood by a “communication interface” is, in particular, an interface that advantageously is intended at least to receive digitally coded information. Preferably, the communication interface is intended to acquire the energy-availability characteristic from the motor vehicle. The communication interface is in the form of an interface and, in particular, engaging in wire-bound communication, advantageously, however, is in the form of a CAN interface, a LIN interface and/or a FlexRay interface. Preferably, the communication interface is intended to communicate via an electrical conductor which supplies the storage-battery inductive charging device at least with the electrical charge energy. Alternatively or additionally, the communication interface has an interface communicating in wireless fashion, e.g., a Bluetooth interface and/or a Zigbee interface.

Furthermore, the storage-battery inductive charging device may include a sensor that, in at least one operating state, ascertains the energy-availability characteristic, thereby making it possible to achieve an especially inexpensive and uncomplicated embodiment. The sensor preferably determines a voltage applied at an energy input of the storage-battery inductive charging device. In particular, a “sensor” is to be understood as a means which is intended to convert a physical characteristic quantity into a preferably digital characteristic quantity able to be processed by the functional unit. Preferably, the sensor is formed at least partially in one piece with the functional unit. Alternatively, the sensor is formed separately from the functional unit. In particular, the sensor takes the form of an analog-to-digital converter. The sensor advantageously ascertains an absolute value of the energy-availability characteristic. Preferably, the energy input is intended at least to acquire the charge energy with a voltage from 6 volts to 400 volts, advantageously from 8 to 60 volts, especially advantageously, from 10 to 30 volts.

In addition, the functional unit is intended to start the process of charging the charging coil as a function of the energy-availability characteristic, which means the charging process may be started advantageously as soon as sufficient energy is able to be made available, e.g., when a motor of the motor vehicle is running. To be understood in particular by the term “start” is that the functional unit begins to drive the charging coil in such a way that the charging coil commences transmitting a charge energy to the hand-held-tool storage battery. Preferably, the functional unit starts the charging process when the motor vehicle is storing sufficient energy and/or is generating sufficient power.

In addition, the functional unit is intended to stop the process of charging the charging coil as a function of the energy-availability characteristic, which means the charging process may be terminated and/or interrupted advantageously when sufficient energy cannot be made available, e.g., when a storage battery of the motor vehicle is discharged to a great extent. By “stop” is to be understood, in particular, that the functional unit interrupts and/or terminates a transfer of charge energy from the charging coil to the hand-held-tool storage battery. The functional unit advantageously stops the charging process when the motor vehicle is not storing sufficient energy, in particular, is generating inadequate power and/or when other loads of the motor vehicle need the energy available.

Furthermore, the storage-battery inductive charging device may have at least one further charging coil, the functional unit being intended to prioritize a charging process of at least one of the charging coils, advantageously allowing a plurality of hand-held-tool storage batteries to be charged at different points in time with different energies and/or with different powers. In particular, by “prioritize” is to be understood that the functional unit starts a charging process of one of the charging coils first and/or stops it on the basis of information. With the aid of the charging coils, the functional unit preferably charges the one hand-held-tool storage battery first and then a second hand-held-tool storage battery. Using the charging coils, the functional unit preferably charges the hand-held-tool storage batteries completely one after another.

In one advantageous development of the present invention, the functional unit is intended to prioritize the charging process of at least one of the charging coils as a function of job information, which means the functional unit is able to charge hand-held-tool storage batteries necessary for the next job first. In particular, “job information” is to be understood as information about a planned utilization of a hand-held tool operated by the hand-held-tool storage battery over a period of time. The job information preferably includes information as to which hand-held tool is needed first for the next job. The job information advantageously has information as to which hand-held tool is needed the most for the next job. The functional unit preferably receives the job information. In particular, the functional unit is intended to store job information of several jobs. Preferably, the hand-held-tool storage battery and/or the hand-held tool has/have an identification element which is intended at least to identify the hand-held-tool storage battery and/or the hand-held tool especially clearly. The identification element preferably has information which describes a type of a hand-held tool. The storage-battery inductive charging device advantageously has a recognition element which is intended to detect a characteristic of the identification element. The identification element is formed as an identification element appearing useful to one skilled in the art, preferably, however, as optical code, as an RFID chip and/or, advantageously, as a characteristic stored in an arithmetic-logic unit of the hand-held-tool storage battery and/or of the hand-held tool. Preferably, the storage-battery inductive charging device transmits the characteristic of the identification means on a same path at least as charging-process information. “Charging-process information” is to be understood, in particular, as information which the hand-held-tool storage battery transmits to the storage-battery inductive charging device for controlling and/or regulating the charging process. Alternatively or additionally, the functional unit could prioritize a charging coil based on its embodiment. That means, in particular, that the functional unit prioritizes one charging coil which is intended to charge a specific type of storage battery that, according to the job information, is to be charged first and/or the most.

In a further development, the functional unit is intended to prioritize the charging process of at least one of the charging coils as a function of usage information, which means in one operating state, a hand-held-tool storage battery used the most is advantageously charged first. In particular, “usage information” is to be understood as information which describes a frequency with which the hand-held-tool storage battery is utilized. With the aid of the charging coils, in particular, the functional unit preferably charges a frequently utilized hand-held-tool storage battery first and/or with more charge energy. Preferably, the functional unit is intended to retrieve the usage information from the hand-held-tool storage battery and/or from the hand-held tool and/or, in particular, to store it. Alternatively or additionally, the functional unit could store how much charge energy is transferred by which charging coil to the hand-held-tool storage battery during a charging process.

In addition, the functional unit is intended to prioritize the charging process of at least one of the charging coils as a function of operator-input information, thereby advantageously allowing the operator to influence which hand-held-tool storage battery is charged first. In particular, “operator-input information” is to be understood as information which is a function of an interaction with an operator. The storage-battery inductive charging device preferably has an operator-control element, the operator-input information being a function of its actuation. Preferably, one hand-held-tool storage battery selected by an operator using the operator-control element in particular is charged first and/or with more charge energy by the functional unit with the aid of one of the charging coils.

Furthermore, the present invention is based on a hand-held-tool storage-battery inductive charging system having an energy distributor, a first storage-battery inductive charging device according to the invention and at least one second storage-battery inductive charging device, the energy distributor being intended to distribute a charge energy to the storage-battery inductive charging devices and to acquire the energy-availability characteristic, thereby advantageously permitting a plurality of storage-battery inductive charging devices to be coordinated during the charging of the hand-held-tool storage batteries. In particular, only a minor intervention into the motor vehicle which supplies the hand-held-tool storage-battery inductive charging system with energy is necessary.

An “energy distributor” is to be understood especially as a device which is intended to acquire a charge energy and to output it to the storage-battery inductive charging devices. Preferably, the energy distributor is intended to acquire the charge energy with a voltage from 6 volts to 400 volts, advantageously from 8 to 60 volts, especially advantageously, from 10 to 30 volts. The first storage-battery inductive charging device preferably has at least one of the charging coils. The second storage-battery inductive charging device advantageously has at least one of the charging coils. The energy distributor preferably has a communication interface for receiving the energy-availability characteristic and/or a sensor for ascertaining it. Preferably, the energy distributor is formed separately from the storage-battery inductive charging devices. Alternatively or additionally, the energy distributor could be formed at least partially in one piece with a storage-battery inductive charging device according to the invention, and advantageously distribute the charge energy to the at least two charging coils of the storage-battery inductive charging device. In particular, the term “acquire” is to be understood as to ascertain and/or to receive.

### BRIEF DESCRIPTION OF THE DRAWING

The FIGURE shows one exemplary embodiment of the present invention.

The FIGURE and the specification contain numerous features in combination. One skilled in the art will expediently examine the features individually as well, and combine them to form further useful combinations.

### DETAILED DESCRIPTION OF THE EXEMPLARY EMBODIMENT

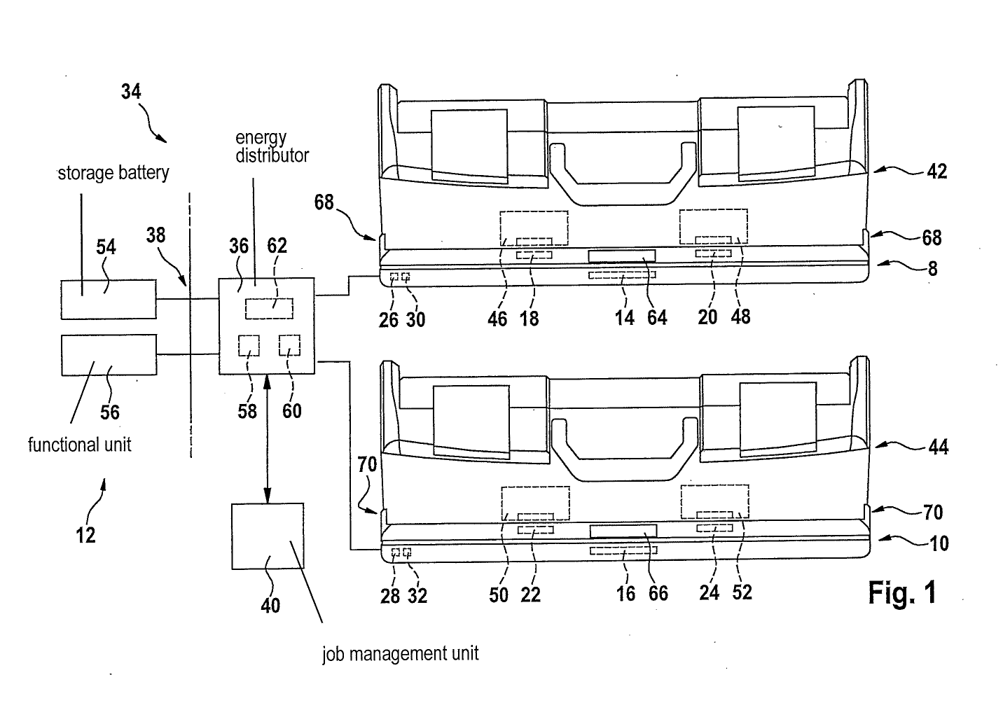

FIG. 1 shows a partially schematic representation of a hand-held-tool storage-battery inductive charging system 34 having a first storage-battery inductive charging device 8 according to the present invention, a second storage-battery inductive charging device 10 according to the invention, an energy distributor 36, a motor-vehicle interface 38, a job-management unit 40, two hand-held-tool cases 42, 44 and four hand-held-tool storage batteries 46, 48, 50, 52. Alternatively, the system could have a single storage-battery inductive charging device or more than two storage-battery inductive charging devices. A motor vehicle 12 makes a charge energy and an energy-availability characteristic available. Storage-battery inductive charging devices 8, 10 are intended to be secured in an interior of motor vehicle 12. Motor-vehicle interface 38 connects a storage battery 54 and/or an alternator (not shown more precisely) and a functional unit 56 of motor vehicle 12 to energy distributor 36.

Energy distributor 36 has a first communication interface 58, a second communication interface 60 and a functional unit 62. Energy distributor 36 is intended to distribute a charge energy, coming from storage battery 54 of motor vehicle 12, to storage-battery inductive charging devices 8, 10, and to acquire the energy-availability characteristic of motor vehicle 12. In addition, functional unit 62 of energy distributor 36 communicates with motor vehicle 12 and storage-battery inductive charging devices 8, 10 via first communication interface 58 of energy distributor 36. Alternatively, a functional unit could communicate with motor vehicle 12 and storage-battery inductive charging devices 8, 10 via various communication interfaces. Second communication interface 60 of energy distributor 36 takes the form of a mobile radio communications interface. Functional unit 62 of energy distributor 36 is intended to receive job information from job-management unit 40 via second communication interface 60. Job-management unit 40 takes the form of a computer in a company of the operator in which jobs which the operator is handling are managed.

Storage-battery inductive charging devices 8, 10 each include a functional unit 14, 16, two charging coils 18, 20, 22, 24, a communication interface 26, 28, a sensor 30, 32, an operator-control device 64, 66 and a case holder 68, 70. In at least one operating state, communication interfaces 26, 28 of storage-battery inductive charging devices 8, 10 receive the energy-availability characteristic of motor vehicle 12. In at least one operating state, sensors 30, 32 ascertain a further energy-availability characteristic by measuring a supply voltage. Functional units 14, 16 are intended to regulate a charging process of charging coils 18, 20, 22, 24 at least as a function of the energy-availability characteristic of sensors 30, 32 and/or the energy-availability characteristic of motor vehicle 12. During the charging process, charging coils 18, 20, 22, 24 transfer a charge energy inductively to hand-held-tool storage batteries 46, 48, 50, 52. Functional units 14, 16 communicate with energy distributor 36, and especially with respective other storage-battery inductive charging device 8, 10 via communication interfaces 26, 28. Case holders 68, 70 are intended to secure each respective hand-held-tool case 42, 44 in a case-accommodation area of storage-battery inductive charging devices 8, 10. Case holders 68, 70 are in each instance disposed partially on opposite sides of the case-accommodation area. Each charging coil 18, 20, 22, 24 is intended to charge one of hand-held-tool storage batteries 46, 48, 50, 52, which are disposed in one of hand-held-tool cases 42, 44.

After ending a job, an operator latches hand-held-tool cases 42, 44 on storage-battery inductive charging devices 8, 10 with the aid of case holders 68, 70. In each instance, hand-held-tool storage batteries 46, 48, 50, 52 disposed in hand-held-tool cases 42, 44 send an identification characteristic, instantaneous state-of-charge information and/or usage information to functional units 14, 16 of storage-battery inductive charging devices 8, 10. The usage information includes information as to with which hand-held tool respective hand-held-tool storage battery 46, 48, 50, 52 was last used and/or with which hand-held tool respective hand-held-tool storage battery 46, 48, 50, 52 is connected at the moment. In addition, the usage information has information as to how frequently respective hand-held-tool storage battery 46, 48, 50, 52 has been used over a period of time. Functional units 14, 16 are intended to acquire operator-input information of the operator with the aid of operator-control devices 64, 66 of storage-battery inductive charging devices 8, 10. The operator-input information determines at least one of hand-held-tool storage batteries 46, 48, 50, 52 whose charging process is started first. Alternatively or additionally, the operator could input the operator-input information at an operator-control device of an energy distributor and/or at a separate operator-control device of a hand-held-tool storage-battery inductive charging system 34, the operator-control device preferably being disposed in a driver's cab of motor vehicle 12. Furthermore, the one operator-control device could take the form of a mobile telephone which is intended for the input of the operator-input information into it. Functional units 14, 16 of storage-battery inductive charging devices 8, 10 transmit the identification characteristics, the state-of-charge information, the usage information and the operator-input information to energy distributor 36.

Energy distributor 36 receives the identification characteristics, the state-of-charge information, the usage information of hand-held-tool storage batteries 46, 48, 50, 52 and the operator-input information. In addition, energy distributor 36 receives job information from job-management unit 40. The job information indicates which hand-held tools are needed first and/or the most for a next job. Furthermore, energy distributor 36 receives the energy-availability characteristic of motor vehicle 12 from functional unit 56 of motor vehicle 12. Alternatively or additionally, an energy distributor could ascertain an energy-availability characteristic by measuring the voltage made available by storage battery 54 of motor vehicle 12. The energy-availability characteristic indicates how much energy may be withdrawn from storage battery 54 of motor vehicle 12 to charge hand-held-tool storage batteries 46, 48, 50, 52 without storage battery 54 of motor vehicle 12 being exhaustively discharged and/or so that sufficient energy remains in storage battery 54 to start motor vehicle 12. In addition, the energy-availability characteristic indicates the power with which the energy may be withdrawn, especially how much power an alternator of motor vehicle 12 is making available and/or how much power may be withdrawn without tripping a protection device of motor vehicle 12.

Functional unit 62 of energy distributor 36 is intended to plan the charging process of hand-held-tool storage batteries 46, 48, 50, 52 on the basis of the energy-availability characteristics, the identification characteristics, the state-of-charge information, the usage information and the operator-input information. The planning of the charging process is configurable by an operator. In so doing, the following parameters of the planning of the charging process are configurable in various manners:
A sequence in which hand-held-tool storage batteries 46, 48, 50, 52 are at least partially charged, e.g., the same hand-held-tool storage battery 46, 48, 50, 52 is always charged first.
A point in time at which the charging process of individual hand-held-tool storage batteries 46, 48, 50, 52 starts, e.g., immediately upon switching on the ignition of motor vehicle 12, after a motor of motor vehicle 12 has started and/or after motor vehicle 12 has been connected to an external electrical energy source not shown in greater detail here.
A point in time at which the charging process of individual hand-held-tool storage batteries 46, 48, 50, 52 stops, e.g., upon reaching a minimal voltage of storage battery 54 of motor vehicle 12, in response to a stopping of motor vehicle 12 and/or after an adjustable charging time.
A value up to which hand-held-tool storage batteries 46, 48, 50, 52 are charged, e.g., up to a maximum possible capacity and/or up to a capacity which permits a maximum service life of hand-held-tool storage batteries 46, 48, 50, 52.
A priority, such that hand-held-tool storage batteries 46, 48, 50, 52 which are connected to a hand-held tool during the charging process are to be charged first.
A priority, such that hand-held-tool storage batteries 46, 48, 50, 52 are to be charged as a function of the state-of-charge information, e.g., that a hand-held-tool storage battery 46, 48, 50, 52 charged the least should be charged first.
That hand-held-tool storage batteries 46, 48, 50, 52 should be charged as a function of the usage information, e.g., that a hand-held-tool storage battery 46, 48, 50, 52 used most often should be charged first.
That hand-held-tool storage batteries 46, 48, 50, 52 should be charged as a function of the operator-input information, e.g., that a hand-held-tool storage battery 46, 48, 50, 52 selected by the operator prior to the charging process should be charged first and/or hand-held-tool storage batteries 46, 48, 50, 52 should be charged in a sequence selected by the operator.
A maximum power withdrawn from motor vehicle 12, particularly as a function of a protection device with which motor-vehicle interface 38 of motor vehicle 12 is protected.

When, based on the energy-availability characteristic, functional unit 62 of energy distributor 36 determines that the charging process can be started, functional unit 62 of energy distributor 36 transmits the planned charging process to storage-battery inductive charging devices 8, 10 and/or storage-battery inductive charging devices 8, 10 make the suitable charging power available. Functional units 14, 16 of storage-battery inductive charging devices 8, 10 start and stop a charging process of individual charging coils 18, 20, 22, 24 on the basis of the planned charging process. Thus, functional units 14, 16 of storage-battery inductive charging devices 8, 10 prioritize the charging processes of individual charging coils 18, 20, 22, 24 as a function of the job information, the usage information and/or the operator-input information.

If only one of storage-battery inductive charging devices 8, 10 is needed, it may be connected directly to motor vehicle 12. Storage-battery inductive charging devices 8, 10 are intended to communicate directly with functional unit 56 of motor vehicle 12. Functional units 14, 16 of storage-battery inductive charging devices 8, 10 are intended to plan the charging process of respective hand-held-tool storage batteries 46, 48, 50, 52 as described above.

What is claimed is:

1. A storage-battery inductive charging device, comprising:
at least one functional unit; and
at least one charging coil;
wherein the functional unit is configured to control a charging process of the charging coil as a function of at least one energy-availability characteristic.

2. The storage-battery inductive charging device as recited in claim 1, wherein the storage battery inductive charging device is for a motor vehicle.

3. The storage-battery inductive charging device as recited in claim 1, further comprising:
a communication interface which, in at least one operating state, receives the energy-availability characteristic.

4. The storage-battery inductive charging device as recited in claim 1, further comprising:
a sensor which, in at least one operating state, ascertains the energy-availability characteristic.

5. The storage-battery inductive charging device as recited in claim 1, wherein the functional unit is configured to start the charging process of the charging coil as a function of the energy-availability characteristic.

6. The storage-battery inductive charging device as recited in claim 1, wherein the functional unit is configured to stop the charging process of the charging coil as a function of the energy-availability characteristic.

7. The storage-battery inductive charging device as recited in claim 1, further comprising:
at least one further charging coil;
wherein the functional unit is configured to prioritize a charging process of at least one of the charging coils.

8. The storage-battery inductive charging device as recited in claim 7, wherein the functional unit is configured to prioritize the charging process of at least one of the charging coils as a function of job information.

9. The storage-battery inductive charging device as recited in claim 7, wherein the functional unit is configured to prioritize the charging process of at least one of the charging coils as a function of usage information.

10. The storage-battery inductive charging device as recited in claim 7, wherein the functional unit in configured to prioritize the charging process of at least one of the charging coils as a function of operator-input information.

11. A hand-held-tool storage-battery inductive charging system, comprising:
an energy distributor;
a first and a second storage-battery inductive charging device, each of the first and second storage-battery inductive charging devices including at least one functional unit, at least one charging coil, wherein the functional unit is configured to control a charging process of the charging coil as a function of at least one energy-availability characteristic;
wherein the energy distributor is configured to distribute a charge energy to the storage-battery inductive charging devices and to acquire the energy-availability characteristic.

12. A method utilizing a storage-battery inductive charging device, having at least one functional unit, the method comprising:
controlling, by the functional unit, a charging process as a function of at least one energy-availability characteristic.
